(19) United States
(12) Patent Application Publication
(10) Pub. No.: US 2025/0250203 A1
(43) Pub. Date: Aug. 7, 2025

(54) COMPOSITION

(71) Applicant: LOW CARBON MATERIALS LIMITED, Stockton-on-Tees (GB)

(72) Inventors: Philip BUCKLEY, Seaham (GB); Scott BUSH, Seaham (GB); Natasha BOULDING, Seaham (GB)

(21) Appl. No.: 18/701,101

(22) PCT Filed: Oct. 14, 2022
(86) PCT No.: PCT/GB2022/052615

§ 371 Date: Apr. 12, 2024

(30) Foreign Application Priority Data
Oct. 15, 2021 (GB) 2114789.7
Jul. 19, 2022 (GB) 2210576.1

(51) Int. Cl. C04B 18/02; C04B 14/06; C04B 14/10; C04B 14/28; C04B 18/08; C04B 18/20; C04B 20/04

(52) U.S. Cl. CPC C04B 18/021; C04B 14/06; C04B 14/10; C04B 14/28; C04B 18/085; C04B 18/20; C04B 20/04

(57) ABSTRACT

The present invention relates to a plastic aggregate comprising the steps of: (i) mixing plastic and at least one cementitious binder to form a first composition, wherein the particles of the plastic have a size distribution between 0.1 to 6 mm; (ii) providing a second composition comprising water, (iii) mixing together the first and second compositions to form a plastic aggregate mixture; and (iv) compressing and heating the plastic aggregate mixture to form the plastic aggregate. The present invention further relates to a plastic aggregate pellet and methods of manufacturing a concrete composition comprising a plastic aggregate.

### COMPOSITION

### Field of Invention

The present invention relates to repurposing waste plastic-based foams for use in the building industry.

### Background of the Invention

Large quantities of plastic waste are produced each year and are disposed of in landfill, incinerated or recycled. Disposing plastic in landfill and incinerating plastic contributes to environmental pollution. Recycling plastic may simultaneously avoid environmental pollution and provide useful products.

Plastic-based foams are used in abundance globally, particularly in industries such as construction, transportation, home furniture, carpet, noise reduction, and vibration reduction. However, currently, these foam materials are difficult to recycle. For instance, one of the most commonly used plastic foams is polyurethane (PUR); this type of foam is not currently recycled, primarily because PUR is a thermoset plastic. Additionally, the only known recycling process for it is incredibly expensive and laborious. Consequently, waste PUR is incinerated or disposed of in landfill.

Incineration releases vast amounts of carbon dioxide equivalents (CO₂ eq) into the atmosphere which contributes to climate change. For example, around 25% of all plastic waste is incinerated and this is estimated to be causing the release of 5 million tonnes of CO₂ eq in the UK alone (PUR incineration releases 2.44 kg CO₂ eq/kg). It is vital that the burning of plastic waste, particularly PUR, is stopped or limited, in order to help achieve Net Zero.

Therefore, there is a need to repurpose waste plastic-based foams for environmental reasons (i.e. limiting the effects of CO₂ eq emissions linked to climate change). Such repurposing would also generate economic value, as it would allow a waste product (which would otherwise be incinerated or disposed of in landfill) to be used in the production of a valuable product.

The use of plastic (such as PUR) powder with little or no pre-treatment in concrete has proven to result in poor mechanical properties, mainly because of the low compatibility of the plastic with the concrete matrix and high surface area. The incompatibility usually leads to a non-homogeneous distribution of the plastic in the matrix, with a partial or complete segregation of the two materials. The result is a much weaker piece of concrete, compared to the use of aggregate of composite origin.

Therefore, there is a need to develop a plastic aggregate that is compatible with the concrete matrix, so that once it is incorporated into concrete it will not detrimentally affect the strength of the resulting concrete.

### SUMMARY OF THE INVENTION

The present invention seeks to address the problem outlined above by repurposing waste plastic-based foams (which would otherwise be typically incinerated or disposed of in landfill) into a useable plastic aggregate for use in manufacturing valuable concrete compositions. The plastic aggregate is mainly intended to replace at least a part of the natural aggregate used in concrete.

The methods of manufacturing and the concrete compositions of the present invention provide an environmental benefit, as they avoid the CO₂ eq emissions associated with the otherwise incineration of the waste plastic-based foams. Additionally, as the plastic aggregate is intended to replace at least a part of the natural aggregate, the methods of manufacture and the concrete compositions of the present invention also reduce the environmental impact associated with sourcing the natural aggregates. Reducing the use of natural aggregates is further beneficial as the natural aggregates are becoming scarce and more costly owing to their overuse.

The concrete compositions of the present invention may be used, for instance, in the building industry to manufacture building components having similar compressional strength as incumbent blocks (as per British standard), but advantageously having lower thermal conductivities and densities.

Accordingly, a first aspect of the invention is a method of manufacturing a concrete composition comprising the step of mixing the components comprising:
i) plastic aggregate derived from waste plastic-based foam; and
ii) cementitious binder,
to form the concrete composition.

A second aspect of the invention is a concrete composition obtainable by the method of the first aspect.

A third aspect of the invention is a concrete composition comprising plastic aggregate derived from waste plastic-based foam.

A fourth aspect of the invention Is a method of manufacturing a plastic aggregate comprising the steps of:
i) mixing plastic and at least one cementitious binder to form a first composition, wherein the particles of the plastic have a size distribution between 0.1 to 6 mm;
ii) providing a second composition comprising water;
iii) mixing together the first and second compositions to form a plastic aggregate mixture; and
iv) compressing and heating the plastic aggregate mixture to form the plastic aggregate.

A fifth aspect of the invention is a plastic aggregate obtainable by the method of the fourth aspect of the invention.

A sixth aspect of the invention is a plastic aggregate pellet comprising:
(i) a plastic;
(ii) at least one cementitious binder; and
(iii) water.

A seventh aspect of the invention is a concrete block comprising the plastic aggregate of the sixth aspect of the invention.

### DESCRIPTION OF THE FIGURES

FIG. 1 shows a drawing of a concrete block of the invention (3D).

FIG. 2 shows front and side view representations of a concrete block of the invention (2D).

FIG. 3 shows the compressive strength after 2 and 7 days of curing of precast concrete in which 25% in volume of the large aggregate has been substituted with the corresponding volume of plastic aggregate pellets, plastic aggregate mix, PUR-only pellets and PUR powder.

FIG. 4 shows an example of plastic powder segregation into a concrete matrix.

FIG. 5 shows the compressive strength of GGBS based concrete over time, with the addition of sodium hydroxide, sodium carbonate or both.

FIG. 6 shows the resistance to tumbling for graphene-containing plastic aggregate.

FIG. 7 shows the compressive strength of concrete comprising graphene-plastic aggregate pellets.

FIG. 8 shows the resistance to tumbling for pigmented 4 mm aggregate pellets.

FIG. 9 shows the resistance to tumbling for pigmented 6 mm aggregate pellets.

FIG. 10 shows the resistance to tumbling for pigmented 8 mm aggregate pellets.

FIGS. 11 and 12 show the setup of concrete cubes for the sunlight exposure experiment described in Example 6.

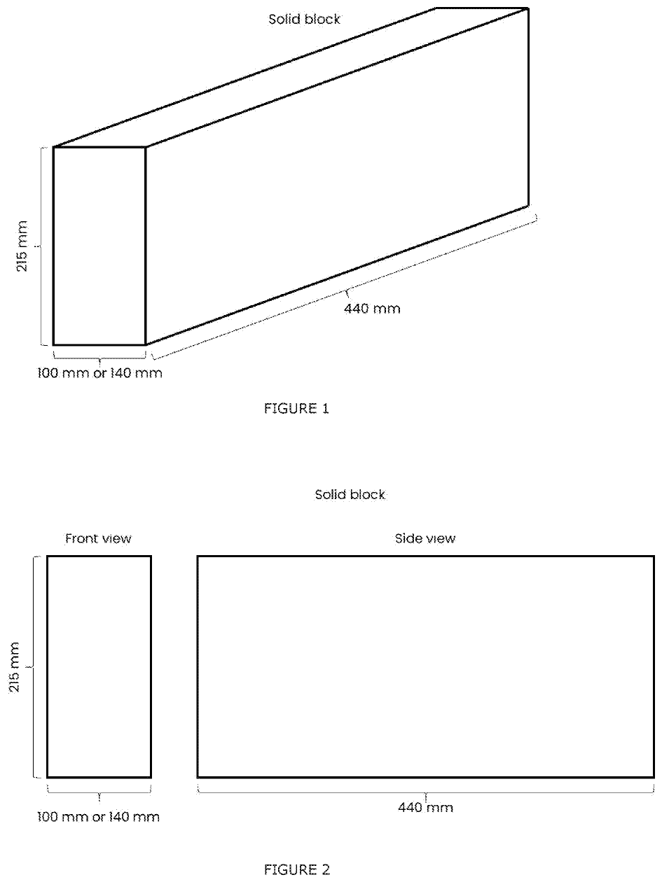

### DETAILED DESCRIPTION OF THE INVENTION

Unless indicated otherwise, all technical and scientific terms used herein will have their common meaning as understood by one of ordinary skill in the art to which this invention pertains.

The term “comprising” or variants thereof will be understood to imply the inclusion of a stated element, integer or step, or group of elements, integers or steps, but not the exclusion of any other element, integer or step, or group of elements, integers or steps.

The term “consisting” or variants thereof is to be understood to imply the inclusion of a stated element, integer or step, or group of elements, integers or steps, and the exclusion of any other element, integer or step or group of elements, integers or steps.

The term “about” herein, when qualifying a number or value, is used to refer to values that lie within ±5% of the value specified. For example, if a particle size range is specified to be about 60 μm to about 4 mm, particle sizes of 57 μm to 4.2 mm are included.

“wt %” is a common abbreviation in the art to mean the “weight %” with respect to the total weight of the article/material referred to.

“Thermosetting polymer” refers to a polymer, which on curing, irreversibly forms an infusible, insoluble polymer network known as a thermoset.

In a first aspect, the invention provides a method of manufacturing a concrete composition comprising the step of mixing the components comprising:
i) plastic aggregate derived from waste plastic-based foam; and
ii) cementitious binder,
to form the concrete composition.

The components may further comprise:
iii) a natural aggregate; and/or
iv) water.

The term “aggregate” is used herein to refer to particulate material.

Suitably the plastic used to form the plastic aggregate is derived from a waste plastic-based foam. “Waste plastic-based foam” refers to plastic-based foam materials that have been used in a first instance, such as in appliances, insulation or furniture. The materials are then being disposed of and are not recycled. As described in the background, they would typically be incinerated or disposed of in a landfill site after their first use. Waste plastic-based foams are generally grey or yellow, beige or cream in colour, and have lower densities (between 48 and 961 kg/m³) compared to other plastics (the densities of PE, PP and PS are approximately 901 kg/m³, 895 kg/m³ and 1050 kg/m³, respectively). Waste plastic-based foams have a cellular structure (closed or open depending on rigidity), are thermoset plastics, and often contain a urethane linkage.

“Rigid foam” refers to a plastic-based foam material which typically has a closed cell structure. The density is typically regulated by the addition of blowing agents. Typically the density of rigid foam is up to 800 kg/m³. “Flexible foam” refers to a plastic-based material which typically has an open cell structure. Typically the density of flexible foam is around 15 kg/m³ to 150 kg/m³. Because of the very fine cell structure of rigid and semi-rigid foams, mechanical handling like drilling, milling or grinding is possible.

Suitably, the plastic, such as the waste plastic-based foam, used in the present invention may be a rigid or flexible foam. Preferably the waste-plastic based foam is a rigid foam.

Most commonly used plastic foams comprise isocyanate. Polymer foams containing isocyanate monomers are referred to herein as “Isocyanate-based foams”. The skilled person would be able to determine whether a given polymer contains isocyanate monomers using standard techniques known in the art. Isocyanates are compounds containing the isocyanate group (—N═C═O). They react with nucleophiles such as alcohols (containing the hydroxy group), amines or water. Upon treatment with an alcohol, an isocyanate forms a urethane linkage. If a diisocyanate is treated with a compound containing two or more hydroxyl groups, such as a diol or a polyol, polymer chains are formed, which are known as polyurethanes. Common isocyanates used in the formation of foam plastics include methylene diphenyl dilsocyanate (MDI) and toluene dilsocyanate (TDI).

Suitably, the plastic, such as the waste plastic-based foam used in the present invention comprises an isocyanate-based foam, such as polyurethane (PUR), polyisocyanurate (PIR) or polyurea.

In a preferred embodiment, the plastic, such as the waste plastic-based foam, comprises polyurethane or polyisocyanurate. More preferably, the waste plastic-based foam is polyurethane.

“Cementitious binder” refers to a material or substance that adheres other materials together to form, set and harden the resulting concrete composition. “Cementitious binder” encompasses cement, a slag (such as ground granulated blast furnace slag (GGBS)), pulverised fly ash (also known as pulverised fuel ash), Portland cement, pozzolanic material or geopolymers.

Often, the cement comprises any one or a mixture of calcium oxide, calcium hydroxide and calcium silicate. Typically, the cement is a hydraulic cement such as Portland cement, which reacts with water via Pozzolanic reactions to cure and set. Portland cement is usually made by heating limestone and clay minerals to form a clinker, which is ground and contacted with gypsum. Portland cement typically consists of at least two-thirds by mass of calcium silicates, with the remainder consisting of aluminium- and iron-containing compounds. The ratio of CaO to SiO₂ within Portland cement is at least 2:1.

“Geopolymers” are amorphous, alumina-silicate binder materials. “Geopolymers” encompass metakaolin.

Suitably, the cementitious binder used in the present invention may comprise one or a mixture of one or more of cement, a slag (such as GGBS), pulverised fly ash or geopolymers. In one embodiment, the cementitious binder may comprise cement and/or a slag (such as GGBS). More preferably, the cementitious binder comprises cement. In one embodiment, the cement comprises Portland cement.

The term “natural aggregate” encompasses aggregates formed from natural materials such as sand, gravel or crushed stone. “Sand” refers to particulate rocks and minerals, often comprising silica (SiO₂), of sizes of about 60 μm to about 4 mm. Commercial sand is available in many different varieties including sharp sand, builders sand, and plaster sand. “Sharp sand” comprises angular particles leading to a coarse texture. It may be mixed with cement to form concrete or mortar of high strength, which are often used in construction. Builders sand and plastering sand comprise smooth particles leading to a fine structure. Builders sand and plaster sand may be mixed with cement to form concrete or mortar of low strength but high flexibility. Compositions comprising cement and builders sand are often used in bricklaying, whilst compositions comprising cement and plaster sand are often used in rendering (typically of external and internal walls) and plastering.

Suitably, the natural aggregate comprises one or more small aggregate. Preferably, the one or more small aggregate comprises sand, preferably sharp sand.

The diameter of the one or more small aggregate particles may be between 0 mm and 4 mm.

Suitably, the natural aggregate comprises one or more large aggregate. Preferably, the one or more large aggregate comprises limestone, dolomite, granite, basalt, sandstone, or quartzite, or a mixture of one or more thereof. More preferably the one or more large aggregate comprises limestone.

The diameter of the one or more large aggregate particles may be between 4.01 mm and 20 mm, preferably between 4.01 mm and 15 mm, more preferably between 5 mm and 10 mm, such as between 6 mm and 10 mm.

Suitably, the components mixed in the method of the present invention may further comprise a secondary aggregate.

As used herein “secondary aggregate” refers to an aggregate other than natural aggregates or the plastic aggregate. “Secondary aggregates” encompass recycled building materials, such as demolition waste, crushed concrete or crushed recycled blocks.

Suitably, the components mixed in the method of the present invention may further comprise an admixture.

As used herein “admixture” refers to a material other than water, aggregates, cementitious materials or fibre reinforcement, which is added to concrete to modify its properties. “Admixture” encompass materials such as air entrainers, water reducers, set retarders, set accelerators or plasticisers.

Suitably, the method of the invention further comprises the following pre-steps:
(i). receiving the waste plastic-based foam such as from a recycler or manufacturer; and/or
(ii). granulating the waste plastic-based foam to form a mixture of plastic particles; and/or
(iii). treating the mixture to form a treated mixture; and/or
(iv). sieving the mixture to size separate the plastic particles; and/or
(v). reforming the mixture by contacting the plastic particles of different sizes with one another.

In one embodiment, the method comprises the pre-steps (i), (iv) and (v). In another embodiment, the method comprises the pre-steps (i), (ii), (iv) and (v). In a further embodiment, the method comprises the pre-steps (i), (iii), (iv) and (v). In a further embodiment, the method comprises the pre-steps (i), (ii), (iii), (iv) and (v).

Suitably, the waste plastic-based foam in step (i) may be received in the form of pellets, powders, panels or briquettes. Preferably, the waste plastic-based foam is received in the form of pellets or powders.

In one embodiment, the waste-plastic based foam may be contaminated with demolition rubble. For example, the waste-plastic based foam in step (i) may be received in the form of pellets, powders, panels or briquettes and said pellets, powders, panels or briquettes are mixed with demolition rubble or comprise demolition rubble. Suitably, the method may comprise an additional step (i-a) of separating the plastic-based foam from said demolition rubble.

Suitably, a mixture of plastic particles according to step (ii) may be produced by granulating waste plastic-based foam of larger size. It is to be understood that plastic-based foam of larger size refers to bulk plastic, i.e. large pieces of plastic-based foam such as rigid or flexible foam sheeting, as well as plastic foam particles that are of larger size than the desired size of the plastic aggregate particles.

The term “granulating” refers to forming into particles, i.e. discrete, solid pieces, and may be achieved by shredding (tearing or cutting), milling (pressing, crushing and/or grinding) and chipping (breaking off pieces).

Granulating may be achieved by any method that reduces the size of the plastic of larger size and forms it into the desired smaller particles. Granulating may be carried out by any one or a combination of methods selected from shredding, milling and chipping. In some embodiments, granulating comprises shredding. In other embodiments, granulating comprises shredding and milling. Typically, granulating comprises shredding followed by milling. The surface texture of the plastic particles following granulation is dependent on the method used to granulate the plastic of larger size. Rougher surfaces are reported to produce better adhesive properties, thus granulating methods that produce more textured surfaces are preferred. Typically, excessive milling of the plastic of larger size is avoided as it may smooth the surfaces of the resulting particles to an undesirable extent.

Suitably, the waste plastic-based foam in step (i) or the granulated mixture of plastic particles in step (ii) may be treated to form a treated mixture.

Suitably, the treating in step (iii) may be pelletising. “Pelletising” refers to the process of densifying plastic particles into pellets using a suitable binder.

Suitably the treating in step (iii) may be agglomeration. “Agglomeration” refers to the process of forming larger plastic particles from smaller plastic particles using a suitable binder.

Suitably the treating in step (iii) may be expansion. “Expansion” refers to the process of forming voids, gas or air pockets inside of a compacted plastic particle using a suitable binder.

The binder may be cementitious or polymeric based. For example, GGBS, cement, lignosulphonates, polymeric sugars.

In some embodiments, the mixture is sieved to size separate the plastic particles. The plastic particles are separated by size using particle sieves of different mesh size. The skilled person is able to determine which mesh sizes are appropriate to use for the size range covered by one size category. For example, if it is preferable to separate the plastic particles by longest dimension into size categories of <63 μm, >63 μm to <125 μm, >125 μm to <250 μm, >250 μm to <500 μm, >500 μm to <2 mm, >2 mm to <4 mm, >4 mm to <6 mm, >6 mm to <10 mm, >10 mm to <20 mm, >20 mm to <40 mm then mesh sizes of No. 230, 120, 60, 35, 10, 5 should be used. The plastic particles may be separated by sieving in order of increasing or decreasing mesh size. Typically, the plastic particles are separated by sieving through particle sieves of decreasing mesh size (increasing mesh size No.).

Suitably, the plastic particles of different sizes may be contacted with one another. Usually, contacting entails combining and often mixing the particles. Herein, particles are to be regarded as being of different sizes when their longest dimensions differ by more than 5%. For example, if a first particle has a longest dimension of 0.5 mm and a second particle has a longest dimension of 0.48 mm, the two particles differ in longest dimension by 5% or less, and are considered herein to be of similar sizes. Conversely, if a first particle has a longest dimension of 0.5 mm and a second particle has a longest dimension of 0.53 mm, the two particles differ in longest dimension by more than 5%, and are considered herein to be of different sizes.

In one embodiment, the plastic aggregate has a size distribution of 0 mm to about 2 mm, preferably 0 mm to about 1 mm. Preferably, the plastic aggregate is in the form of powder. It is to be understood that the size range given refers to the longest dimension of the plastic particles. At least some of the particles of the aggregate are of sizes that fall within the size range. For example, some of the particles of the aggregate may have sizes of about 1 mm, and the rest of the particles of the aggregate may have sizes greater than about 2 mm. According to particular embodiments, substantially all (more than 90% by weight, often more than 95% by weight, for example more than 98% or 99% by weight) of the plastic particles in the aggregate are of a size from about 0 mm to about 2 mm, or 0 mm to about 1 mm.

In one embodiment, the plastic aggregate has a size distribution of about 2 mm to about 40 mm, preferably about 5 mm to about 10 mm. Preferably, the plastic aggregate is in the form of pellets. It is to be understood that the size range given refers to the longest dimension of the plastic particles. At least some of the particles of the aggregate are of sizes that fall within the size range. For example, some of the particles of the aggregate may have sizes of about 2 mm, and the rest of the particles of the aggregate may have sizes greater than about 40 mm. According to particular embodiments, substantially all (more than 90% by weight, often more than 95% by weight, for example more than 98% or 99% by weight) of the plastic particles in the aggregate are of a size from of about 2 mm to about 400 mm, or 5 mm to about 10 mm.

Suitably, the method of the invention may further comprise the step of using the concrete composition to produce a concrete building component. The concrete building component may be a precast concrete component, such as a column, beam, slab or block. Preferably, the concrete building component is a concrete block.

For the avoidance of doubt, the methods according to the first aspect of the invention may comprise any of the features described below for the third aspect of the invention.

In a second aspect of the invention, a concrete composition or building component is obtainable, such as obtained, by a method of the first aspect of the invention. For the avoidance of doubt, the concrete composition or building component of the second aspect of the invention may comprise any of the features described above for the first aspect or below for the third aspect of the invention.

In a third aspect, the present invention provides a concrete composition comprising plastic aggregate derived from waste plastic-based foam. For the avoidance of doubt, the compositions according to the third aspect of the invention may comprise any of the features described above for the first and second aspect of the invention and any of the features described below for the fifth and sixth aspects of the invention.

Suitably, the concrete composition may further comprise a cementitious binder, a natural aggregate and/or water. Suitably, the concrete composition may further comprise a secondary aggregate.

Suitably, the waste plastic-based foam may comprise an isocyanate-based foam. In one embodiment, the waste plastic-based foam may comprise polyurethane (PUR) or polyisocyanurate (PIR). In a preferred embodiment, the waste plastic-based foam comprises PUR.

Suitably, the plastic aggregate may have a size distribution of 0 mm to about 2 mm, preferably about 0 mm to about 1 mm. Preferably, the plastic aggregate is in the form of a powder. It is to be understood that the size range given refers to the longest dimension of the plastic particles. At least some of the particles of the aggregate are of sizes that fall within the size range. For example, some of the particles of the aggregate may have sizes of about 1 mm, and the rest of the particles of the aggregate may have sizes greater than about 2 mm. According to particular embodiments, substantially all (more than 90% by weight, often more than 95% by weight, for example more than 98% or 99% by weight) of the plastic particles in the aggregate are of a size from of about 0 mm to about 2 mm, or 0 mm to about 1 mm.

Alternatively, the plastic aggregate may have a size distribution of about 2 mm to about 40 mm, preferably about 5 mm to about 10 mm. Preferably, the plastic aggregate is in the form of pellets. It is to be understood that the size range given refers to the longest dimension of the plastic particles. At least some of the particles of the aggregate are of sizes that fall within the size range. For example, some of the particles of the aggregate may have sizes of about 2 mm, and the rest of the particles of the aggregate may have sizes greater than about 40 mm. According to particular embodiments, substantially all (more than 90% by weight, often more than 95% by weight, for example more than 98% or 99% by weight) of the plastic particles in the aggregate are of a size from of about 2 mm to about 40 mm, or about 5 mm to about 10 mm.

Suitably, the natural aggregate may comprise one or more small aggregate. Preferably, the diameter of the one or more small aggregate particles is between 0 mm and 4 mm.

In specific embodiments, the concrete composition comprises 0 to 90 wt %, preferably 0 to 80 wt %, more preferably 0 to 70 wt % small aggregate. Alternatively, the concrete composition may comprise 0 to 60 wt %, preferably 0 to 50 wt %, more preferably 10 to 50 wt % small aggregate. Alternatively, the concrete composition may comprise preferably 10 to 80 wt %, more preferably 15 to 70 wt % small aggregate. Alternatively, the concrete composition may comprise 0 to 45 wt %, more preferably 0 to 40 wt % small aggregate. The wt % of small aggregate refers to wt % relative to the weight of the concrete.

In more specific embodiments, the concrete composition may comprise more than 0 wt % small aggregate, preferably more than 1 wt %, 2 wt %, 3 wt %, 4 wt %, 5 wt %, 10 wt %, 15 wt % or 20 wt % and/or comprise less than 90 wt %, 80 wt %, 70 wt %, 60 wt %, 50 wt %, 45 wt %, 40 wt %, 35 wt %, 30 wt %, 25 wt % small aggregate. For the avoidance of doubt, any of the aforementioned lower range end-points may be combined with any of the aforementioned upper range end-points.

Suitably, the one or more small aggregate may comprise, such as consist of, sand, preferably sharp sand.

Suitably, the natural aggregate may comprise one or more large aggregate. Preferably, the diameter of the one or more large aggregate particles is between 4.01 mm and 20 mm, preferably between 4.01 mm and 15 mm, more preferably 4.01 mm to 10 mm, such as between 5 to 10 mm, such as between 6 mm and 10 mm.

In specific embodiments, the concrete composition comprises 0 to 90 wt %, preferably 0 to 80 wt %, more preferably 0 to 70 wt % large aggregate. Alternatively, the concrete composition may comprise 0 to 60 wt %, preferably 5 to 60 wt %, more preferably 5 to 50 wt % large aggregate. Alternatively, the concrete composition may comprise 5 to 80 wt %, more preferably 5 to 60 wt % large aggregate. Alternatively, the concrete composition may comprise 0 to 50 wt %, preferably 0 to 45 wt %, more preferably 0 to 40 wt % large aggregate. The wt % of large aggregate refers to wt % relative to the weight of the concrete. Suitably the plastic aggregate can replace the large aggregate in known concrete compositions. As such, in some embodiments, the concrete composition comprises substantially no, such as none, large aggregate.

In more specific embodiments, the concrete composition may comprise more than 0 wt % large aggregate, preferably more than 1 wt %, 2 wt %, 3 wt %, 4 wt %, 5 wt %, 10 wt %, 15 wt % or 20 wt % and/or comprise less than 90 wt %, 80 wt %, 70 wt %, 60 wt %, 50 wt %, 45 wt %, 40 wt %, 35 wt %, 30 wt %, 25 wt % large aggregate. For the avoidance of doubt, any of the aforementioned lower range end-points may be combined with any of the aforementioned upper range end-points.

Suitably, the one or more large aggregate comprises limestone, dolomite, granite, basalt, sandstone, or quartzite or a mixture of one or more thereof. Preferably, the one or more large aggregate comprises limestone.

In specific embodiments, the concrete composition may comprise 2 to 75 wt %, preferably 5 to 65 wt %, more preferably 5 to 50 wt % cementitious binder. Alternatively, the concrete composition may comprise 10 to 60 wt %, preferably 10 to 50 wt %, more preferably 15 to 50 wt % cementitious binder. Alternatively, the concrete composition may comprise 2 to 60 wt %, preferably 3 to 50 wt %, more preferably 4 to 40 wt % cementitious binder. Alternatively, the concrete composition may comprise 5 to 75 wt %, preferably 5 to 65 wt %, more preferably 5 to 55 wt % cementitious binder. The wt % of cementitious binder refers to wt % relative to the weight of the concrete.

In more specific embodiments, the concrete composition may comprise more than 2 wt % cementitious binder, preferably more than 3 wt %, 4 wt %, 5 wt %, or 10 wt % and/or comprise less than 75 wt %, 70 wt %, 65 wt %, 60 wt %, 55 wt %, 50 wt %, 45 wt %, 40 wt %, 35 wt %, 25 wt %, or 20 wt % cementitious binder. For the avoidance of doubt, any of the aforementioned lower range end-points may be combined with any of the aforementioned upper range end-points.

Suitably, the cementitious binder may comprise cement (such as Portland cement and/or High Strength Cement (HSC)), a slag (such as ground granulated blast furnace slag (GGBS)), pulverised fly ash (also known as pulverised fuel ash), pozzolans or geopolymers. Preferably, the cementitious binder comprises a slag (such as GBBS) and/or cement, more preferably cement.

Suitably, the concrete composition may comprise 1 to 75 wt %, preferably 1 to 65 wt %, more preferably 1 to 55 wt % plastic aggregate, even more preferably 1 to 50 wt %, more preferably 1 to 40 wt % plastic aggregate. Alternatively, the concrete composition may comprise 5 to 60 wt %, more preferably 10 to 50 wt % plastic aggregate. The wt % of plastic aggregate refers to wt % relative to the weight of the concrete.

In specific embodiments, the concrete composition may comprise more than 1 wt % plastic aggregate, preferably more than 2 wt %, 3 wt %, 4 wt %, 5 wt %, 6 wt %, 7 wt %, 8 wt %, 9 wt %, or 10 wt % and/or comprise less than 75 wt %, 70 wt %, 60 wt %, 50 wt %, 45 wt %, 40 wt %, 35 wt %, 30 wt %, 25 wt %, 20 wt %, 15 wt %, 11 wt % plastic aggregate. For the avoidance of doubt, any of the aforementioned lower range end-points may be combined with any of the aforementioned upper range end-points.

Suitably, the concrete composition comprises between 10 to 90 wt % natural aggregate, preferably 20 to 85 wt %, more preferably 30 to 80 wt %.

Suitably, the concrete composition may comprise between 1 and 20 wt %, preferably between 2 and 20 wt %, more preferably between 2 and 15 wt % water.

Suitably, the concrete composition may comprise a secondary aggregate. Preferably the secondary aggregate comprises demolition waste, such as crushed concrete or recycled blocks. More preferably, the secondary aggregate comprises crushed concrete.

In some embodiments, the concrete composition comprises a strength enhancer, preferably wherein the strength enhancer is graphene. The strength enhancer may be present within the concrete composition by virtue of the concrete composition comprising a plastic aggregate comprising said strength enhancer.

Suitably, the concrete composition comprises a large aggregate. In more particular such embodiments, the plastic aggregate and the large aggregate are in a volume ratio of 1:10 to 10:1, preferably 1:5 to 5; 1, more preferably 1:2 to 2:1, more preferably 1:1.

Suitably, the concrete composition comprises a large aggregate and plastic aggregate comprising graphene. In such embodiments, the large aggregate and the plastic aggregate may be in a weight ratio of 10:1 to 1:10, such as 8:1 to 1:5, 7:1 to 1:3.3, 6:1 to 1:2.5, 5:1 to 1:2, 4:1 to 0.6:1, 3:1 to 0.7:1; preferably 5:1 to 1:2, more preferably 2:1 to 1:2, even more preferably 1.5:1.

In particular such embodiments, the concrete composition comprises a small aggregate. In more particular such embodiments, the plastic aggregate and the small aggregate are in a volume ratio of 1:10 to 10:1, preferably 1:8 to 1:2, more preferably 1:7 to 1:5, even more preferably 1:6.

In particular embodiments, the concrete composition comprises a small aggregate and plastic aggregate comprising graphene. In particular such embodiments, the small aggregate and the plastic aggregate are in a weight ratio of 10:1 to 1:10, such as 8:1 to 2:1, 8:1 to 3:1, 8:1 to 4:1, or 8:1 to 6:1; preferably 2:1 to 1:1, such as 1.5:1.

Suitably, the concrete composition is in the form of a concrete building component, for example a precast concrete component, such as a column, beam, slab or block, preferably a concrete block.

Suitably the concrete block has a length of 100 mm to 600 mm, preferably 215 mm to 440 mm, and/or a thickness of 50 mm to 300 mm, preferably 100 mm to 215 mm, and/or a height of 20 mm to 300 mm, preferably 65 mm to 215 mm.

Suitably, the concrete composition may have a carbon footprint of −0.5 to 0.2 kg CO₂ eq per kg of concrete composition, preferably −0.35 to 0.05 kg CO₂ eq per kg of concrete composition. The skilled person would be able to determine the carbon footprint of a given composition using standard techniques known in the art, such as by carrying out an industry standard life-cycle assessment (LCA) and using Environmental Product Declarations (EPDs).

Suitably, the concrete composition may have a thermal conductivity of 0.1 to 1 W/mK, preferably 0.2 to 0.8 W/mK, more preferably 0.3 to 0.5 W/mK. Alternatively, the concrete composition may have a thermal conductivity of 0.5 to 1.6 W/mK, preferably 0.6 to 1.4 W/mK, more preferably 0.7 to 1.2 W/mK. The thermal conductivity may be measured using standard techniques known in the art, such as using thermal conductivity meters.

Suitably, the concrete composition may have a compressional strength of 1 to 60 N/mm², preferably 3 to 40 N/mm², more preferably 3.6 to 22.5 N/mm².

Suitably, the concrete composition may have a density of 600 to 2500 kg/m³, preferably 1200 to 1600 kg/m³, more preferably 1350 to 1550 kg/m³. Alternatively, the concrete composition may have a density of 1500 to 2500 kg/m³, preferably 1600 to 2200 kg/m³, more preferably 1700 to 2100 kg/m³. The density may be recorded using standard techniques known in the art, such as the British Standard, which involves drying the concrete composition and weighing it.

Plastic particles within the plastic aggregate may be surface-modified to improve interaction of the aggregate with cement. Surface modification may be achieved by exposing the particles to chemicals, gamma irradiation, electron beams or plasma. Surface modification via chemical treatment typically results in the binding of new chemical groups at the surface of the particle.

Atmospheric plasma treatment is limited to ionising chemicals that are gases at atmospheric pressures, which in turn limits the types of plasma generated. Low-pressure plasma treatments may be used as an alternative. In low-pressure plasma treatments, a reaction chamber is evacuated to pressures lower than atmospheric pressure, at which pressures the plasma source of interest becomes gaseous. The plasma source is ionised to produce a flow of low pressure plasma through the chamber (A. Yáñez-Pacios and J. Martín-Martínez, supra; L. Gerenser, J. Adhesion Sci. Technol., 1987, 1(4), 303-318; L. Gerenser, J. Adhesion Sci. Technol., 1993, 7(10), 597-614; R. Foerch, J. Izawa and G. Spears, J. Adhesion Sci. Technol., 1991, 5(7), 549-564; and E. Occhiello et al., J. Appl. Polym. Sci., 1991, 42(2), 551-559).

Suitably, the plastic aggregate may comprise plastics particles that have been treated with low pressure plasma or electron beam. In one embodiment, the plastic aggregate comprises plastic particles that have been treated with low pressure plasma. As described above, the low-pressure plasma is able to react with and bind to the surface of plastic. In an alternative embodiment, the plastic aggregate comprises plastic particles that have been treated with an electron beam.

In a specific embodiment, the plastic aggregate comprises plastics particles that have been treated with low pressure plasma, wherein the plasma comprises ions formed from any one or a combination selected from the group consisting of a carboxylic acid, alcohol, amine, ester, aldehyde, amide, ketone, epoxide, ammonia and peroxide.

In specific embodiments, the plastic aggregate is untreated (such as substantially untreated). As used herein, “untreated plastic aggregate” refers to plastic aggregate that has not been treated with plasma, electron beam, and/or inorganic compounds. In particular embodiments, the plastic aggregate has not been treated with inorganic compounds.

### The Plastic Aggregate

As discussed above, the use of plastic (such as PUR) powder with little or no pre-treatment in concrete has proven to result in poor mechanical properties, mainly because of the low compatibility of the plastic with the concrete matrix and high surface area.

A method to improve the performance of plastic in concrete is to compress plastic powders into coarser particles, using processes like extrusion, pelletisation, pan pelletisation, briquetting, or other similar ways of compression. The larger particles will present a lower surface area in contact with the concrete matrix, reducing the weakening effect of the unfavourable contact between the two. The larger plastic particles, however, will still tend to segregate, even if in a lower extent compared to the powder, and will still constitute zones of weaker material within the concrete matrix due to no connectivity between the powder PUR in the larger particles.

In the present invention, the waste-plastic (e.g. PUR plastic) is compressed into larger particles, such as by using a pelletiser, and held together by a cementitious binder and water. Without wishing to be bound by theory, it is believed that the larger particles will have a lower contact surface area with the concrete matrix but also the presence of the binder will improve the interfacial interaction between the aggregate and the cement matrix due to being similar or the same materials. The effect of the cementitious binder, which will cure in contact with water in the pellets mixture, also causes a general strengthening of the plastic aggregate, reducing the general weakening effect of plastic only (e.g. PUR-only) pellets on the final concrete matrix.

Accordingly, a fourth aspect of the invention is a method of manufacturing a plastic aggregate comprising the steps of:
(i) mixing plastic and at least one cementitious binder to form a first composition, wherein the particles of the plastic have a size distribution between 0.1 to 6 mm;
(ii) providing a second composition comprising water;
(iii) mixing together the first and second compositions to form a plastic aggregate mixture; and
(iv) compressing and heating the plastic aggregate mixture to form the plastic aggregate.

The particles of plastic may be derived from waste plastic-based foam. Suitably the particles of plastic may have a size distribution of about 0.1 mm to about 6 mm, preferably about 0.2 mm to about 5 mm, such as about 0.2 mm to about 3 mm or about 0.2 mm to about 2 mm. It is to be understood that the size range given refers to the longest dimension of the particles of plastic. At least some of the particles of plastic are of sizes that fall within the size range. For example, some of the particles of plastic may have sizes of about 1 mm, and the rest of the particles of plastic may have sizes greater than about 6 mm. According to particular embodiments, substantially all (more than 90% by weight, often more than 95% by weight, for example more than 98% or 99% by weight) of the particles of plastic are of a size from of about 0.1 mm to about 6 mm, preferably about 0.2 mm to about 5 mm, more preferably about 0.2 mm to about 2 mm.

In some embodiments, the size of the particles of plastic, such as those derived from waste plastic-based foam, may be greater than about 0.1 mm, such as greater than about 0.2 mm, 0.3 mm, 0.4 mm, 0.5 mm, 0.7 mm, 0.8 mm, 0.9 mm, 1 mm, 1.5 mm, or 2 mm. In some embodiments, the size of the particles of plastic, such as those derived from waste plastic-based foam, may be less than about 6 mm, such as less than about 5.5 mm, 5 mm, 4.5 mm, 4 mm, 3.5 mm or 3 mm. For the avoidance of doubt, any of the aforementioned lower range end-points may be combined with any of the aforementioned upper range end-points.

Suitably, the cementitious binder may comprise cement (such as Portland cement and/or High Strength Cement (HSC)), a slag (such as ground granulated blast furnace slag (GGBS)), fly ash (also known as pulverised fuel ash), pozzolans, geopolymers, or a mixture of two of more thereof. Preferably, the cementitious binder comprises a slag (such as GGBS), more preferably GGBS.

The preferred binder GGBS represents a lower carbon alternative to Ordinary Portland Cement (OPC). The use of GGBS allows to reduce the embodied carbon of the aggregate and of the final concrete, compared to the use of OPC. GGBS is characterised by an extremely slow curing rate when hydrated and is typically activated by an alkaline solution which increases the curing rate and compressional strengths.

Although the slow curing rate of GGBS could represent an obstacle, during the production of the composite aggregate (such as via pelletisation, which generates high pressure and heat), the pressure and heat improves the aggregates strength due to compaction of the particle and the increased temperature accelerating the reaction of the GGBS with the alkaline activator (i.e. Inorganic base).

Early strength and final strength can also be improved by the use of an activator solution, preferably obtained by adding sodium hydroxide, sodium carbonate or a combination of. A secondary advantage of this process is when scaled up (>0.5 T), the aggregate can retain the heat generated by the process and the heat generated through the hydration reaction for multiple days, this is due to the inherent Insulating properties of the plastic (e.g. PUR), this causes improved compressional strengths.

In some embodiments, the second composition further comprises at least one inorganic base.

The “Inorganic base” acts as an activator. Inorganic bases include a class of inorganic compounds with the ability to react with, that is neutralize, acids to form salts. These compounds comprise strong and weak bases, such as metal hydroxides, alkali metal hydroxides, ammonium hydroxides, alkali metal carbonates or bicarbonates. The term is intended to comprise also substances that can generate bases, i.e. hydroxides, when in contact with water, such as metal and alkali metal oxides, alkaline silicates.

Suitably, the at least one inorganic base comprises an alkali hydroxide, alkali oxide, alkali carbonate, alkaline silicates or a mixture thereof. In some embodiments, the alkali is sodium, potassium or calcium.

Preferably the at least one inorganic base comprises sodium hydroxide, sodium carbonate or a mixture thereof.

Additionally, it has been found by the inventors that unreacted inorganic base in the plastic aggregate diffuses out when combined with particular cementitious binders (for example, GGBS) to form the concrete composition or the concrete block. This diffused inorganic base significantly speeds up the curing of the particular cementitious binders (for example, GGBS) resulting in a harder concrete quicker. This is beneficial as some cementitious binders (for example, GGBS) are known in the industry to take a long time to cure, which results in slow and impractical manufacturing. As such, the method of the fourth aspect may further comprise the step of mixing the plastic aggregate and at least one cementitious binder to form a concrete composition. Preferably the at least one cementitious binder comprises GBBS. The at least one cementitious binder may be a mixture of GGBS and cement.

In some aspects of the method, when particular cementitious binders are used, an inorganic base is not required to cure the binder. As such, suitably there is provided a method that does not require an inorganic base in step ii and the second composition. Exemplary cementitious binders include Portland cement.

The plastic aggregate mixture is compressed and heated to form the plastic aggregate.

Compression is achieved by applying a force to the powdered mixture to combine it. Heat might be generated from the compression process or heat may be applied after the formation of the aggregate by compression.

Suitably, compression and heating may be a single process. In some embodiments, the compression and heating are done by pelletisation. Typically during certain compression methods, such as pelletisation, the heating required is generated naturally from friction during the compression of the mixture being pushed through the die. However, further heating can also be applied after compression to keep the pellets warm for longer to further increase the curing speed.

“Pelletisation” is the process of compressing material into the form of a pellet. Pelletisation includes die mill pelletisation, pan pelletisation, briquetting or extrusion pelletisation. Die mill pelletisation refers to converting finely ground material into free flowing pellets. “Pan pelletisation” refers to mixing material (e.g. finely ground material or seed pellets) with a binder and agitating the resulting mixture until pellets of desired size have formed. “Briquetting” refers to compressing material into a desired form, such as a pellet. “Extrusion pelletising” (also referred to as “compounding”) refers to extruding a mixture (often molten mixture), optionally cooling the mixture, then passing the mixture onto a pelletiser such as a granulator to convert the extrudate into pellets.

In some embodiments, the pelletisation is die mill pelletisation, pan pelletisation, briquetting or extrusion pelletising. Preferably, the pelletisation is die mill pelletisation.

Alternatively, compression and heating may be separated, so that they are carried out as part of separate processes, and/or are carried out at different locations or a different time. In such cases, compression is first carried out, followed by heating. Therefore, in some embodiments, compression and heating are separate processes, wherein compression is carried out before heating. Heat is advantageous to increase the curing of the pellets.

In some embodiments, the compression is done by pelletisation.

In some embodiments, the plastic aggregate is in the form of a pellet.

The width of the plastic aggregate pellet may be 0.5 to 10 mm, such as 1 to 9 mm, 2 to 8 mm, 2 to 7 mm, 2 to 6 mm or 2 to 5 mm, preferably 2 to 8 mm. The length of the plastic aggregate pellet may be 0.5 to 10 mm, such as 1 to 9 mm, 2 to 8 mm, 2 to 7 mm, 2 to 6 mm or 2 to 5 mm, preferably 2 to 8 mm.

An “aspect ratio” is a well-known ratio and is a proportional relationship between the aggregate's length and width. The aspect ratio between the length of the pellet and the width of the pellet may be 0.05 to 20, such as 0.1 to 10, 0.2 to 8, 0.25 to 6, 0.25 to 4, preferably 0.25 to 4. Suitably the plastic aggregate is round and therefore it can be difficult to distinguish between length and width. Thus suitably the aspect ratio is about 1:1.

The ratio between the plastic to cementitious binder is important to achieve the desired strength and density of the resulting aggregate. In some embodiments, the weight ratio of plastic to cementitious binder in the plastic aggregate mixture and/or the plastic aggregate is from 2:1 to 1:10, such as 2:1 to 1:7, 1:1 to 1:5 or 1:1 to 1:4, preferably 2:1 to 1:7.

The amount of water is important for achieving hydration of the cementitious binder and to aid in the pelletisation process. If the amount of water is too high, the resulting mixture will not process efficiently and if the amount of water is too low, the mixture can get stuck in the die and not be processed properly. In some embodiments, the weight ratio of water to cementitious binder in the plastic aggregate mixture and/or the plastic aggregate is from 0.1 to 1, such as 0.2 to 0.6 or 0.3 to 0.5, preferably 0.3 to 0.5.

The amount of inorganic base is important for activating the hydration of the cementitious binder and to achieve a higher final strength of the resulting pellets. In some embodiments, the weight % of inorganic base in the plastic aggregate mixture and/or the plastic aggregate is from 0 to 15% w/w of the cementitious binder, 0.1 to 15% w/w of the cementitious binder, such as 0.5 to 12% w/w, 1 to 10% w/w, or 2 to 10% w/w, preferably 2 to 10% w/w of the cementitious binder.

The strength of the plastic aggregate and the resulting concrete may be increased using strength enhancers. In some embodiments, the method further comprises the step of adding a strength enhancer (preferably graphene) during or between any one of steps (i), (ii) or (iii). In particular embodiments, the strength enhancer (preferably graphene) is added to the first composition during or after step (i), preferably after step (ii) and before step (iii).

The plastic aggregate may be coloured using pigments. In some embodiments, the method further comprises the step of adding a pigment during or between any one of steps (i), (ii) or (iii). In particular embodiments, the pigment is added to the first composition during or after step (i), preferably after step (i) and before step (iii).

Fillers may improve the properties and the microstructure of concrete. In some embodiments, the method further comprises the step of adding a filler during or between any one of steps (i), (ii) or (iii), preferably wherein the filler is limestone or clay. In particular embodiments, the filler is added to the first composition during or after step (i), preferably after step (i) and before step (iii).

In some embodiments, the method of the fourth aspect of the invention further comprises the step of mixing the plastic aggregate and at least one cementitious binder to form a concrete composition.

According to a fifth aspect of the invention, there is provided a plastic aggregate obtainable, such as obtained, by a method of the fourth aspect of the invention.

For the avoidance of doubt, the plastic aggregate of the fifth aspect of the invention may comprise any of the features described above for the first to fourth aspects of the invention and any of the features described below for the sixth aspect of the invention.

According to a sixth aspect of the invention, there is provided a plastic aggregate pellet comprising:
(i) a plastic;
(ii) at least one cementitious binder; and
(iii) water.

Suitably, the plastic aggregate pellet may further comprise at least one additive. Additives include admixture, strength enhancers, rheology modifier, pigment, and fibre.

“Admixture” encompasses materials such as air entrainers, water reducers, set retarders, set accelerators or plasticisers. Admixture includes rosin resin, alkyl sulfonate, aliphatic alcohol sulfonate, protein salt and petroleum sulfonate, soluble inorganic salts of alkali and alkali earth metals (sodium or potassium hydroxide, calcium chloride, bromide and fluoride, sodium and calcium nitrite and nitrate, potassium carbonate, sodium and calcium thiocyanate, sulphate, thiosulphate, perchlorate, silicate, aluminate), carboxylic acids (formic, acetic, propionic and butyric, oxalic) and their salts (Calcium formate, calcium oxalate), lignosulfonates, sulfonated naphthalene formaldehyde (PNS), sulfonated melamine formaldehyde (PMS), vinyl copolymers (VCPs), and polycarboxylic ethers (PCEs). Suitably, the plastic aggregate pellet may further comprise an admixture.

“Strength enhancers” are materials used to increase the strength of the concrete. Strength enhancers include graphene and alkanolamines for example tri-isopropanolamine (TIPA) and Triethanolamine (TEA). Suitably, the plastic aggregate pellet may further comprise a strength enhancer.

In some embodiments, the strength enhancer is graphene. Graphene increases the strength of the plastic aggregate and the strength of the resulting concrete comprising the plastic aggregate. Graphene can be functionalised with surface groups (such as graphene oxide and other forms of functionalised graphene), dispersed in a liquid using a surfactant or used without any dispersion aids, just the pure carbon form.

Modifying the rheological properties of concrete may improve the properties of concrete in the fresh and hardened state, which is particularly important for production and placement of special construction applications such as underwater or self-consolidating concrete. A “rheology modifier” is a material that alters the rheology (i.e. deformation or flowing response to applied forces or stresses) of a fluid composition to which it is added. Rheology modifiers include viscosity modifying agents such as cellulose ethers, natural gums (xanthan, wellan) and starch. Suitably, the plastic aggregate pellet may further comprise a rheology enhancer.

Cement may be coloured using pigments. A “pigment” is a coloured material that is completely or nearly insoluble in water. Pigments include iron oxide, cobalt, titanium dioxide and chromium oxide pigments and carbon black. Suitably, the plastic aggregate pellet may further comprise a pigment.

Fibre-reinforced concrete has greater tensile strength when compared to non-reinforced concrete. Fibers include cellulose fibres, natural fibres, carbon fibres, polyester fibres, glass fibres, polypropylene fibres, and steel fibres. Suitably, the plastic aggregate pellet may further comprise a fibre.

In some embodiments, the plastic aggregate pellet comprises from 0.01 to 5 wt % of the at least one additive, such as 0.1 to 5 wt %, 0.1 to 3 wt %, or 1 to 3 wt %.

Fillers may improve the properties and the microstructure of concrete. Suitably, the plastic aggregate pellet may further comprise at least one filler. The filler may be gypsum, limestone, sand, wood, wood shavings, clay, concrete dust, microsilica, or char, preferably clay, limestone, or a mixture thereof, preferably clay. Suitably, the plastic aggregate may comprise substantially no (such as no) Inorganic base.

In some embodiments, the clay is calcined clay. The calcined clay may be natural or synthetically produced by high temperature kilns.

In particular embodiments, the plastic aggregate pellet comprises calcined clay and high strength cement. In particular such embodiments, the plastic aggregate pellet further comprises a large aggregate, preferably limestone.

In some embodiments, the pellet comprises from 0.01 to 30 wt % of the at least one filler, such as from 0.1 to 25 wt %, 0.5 to 20 wt %, 1 to 20 wt %, or 1 to 10 wt %.

For the avoidance of doubt, the plastic aggregate pellet of the sixth aspect of the invention may comprise any of the features described above for the first to fifth aspects of the invention.

According to a seventh aspect of the invention there is provided a concrete block comprising the plastic aggregate of the sixth aspect of the invention.

For the avoidance of doubt, the concrete block of the seventh aspect of the invention may comprise any of the features described above for the first to sixth aspects of the invention. Further, the plastic aggregate of the fourth to sixth aspects of the invention may be used as the plastic aggregate in the first to third aspects relating to the concrete compositions.

### CLAUSES

Particular embodiments of the invention are illustrated by the clauses below.

1. A method of manufacturing a concrete composition comprising the step of mixing the components comprising:
i) plastic aggregate derived from waste plastic-based foam; and
ii) cementitious binder,
to form the concrete composition.

2. A method of clause 1, wherein the components further comprise:
iii) a natural aggregate; and/or
iv) water.

3. A method according to any preceding clause, wherein the waste plastic-based foam is a rigid or flexible foam, preferably rigid foam.

4. A method according to any preceding clause, wherein the waste plastic-based foam comprises an isocyanate-based foam.

5. A method according to any preceding clause, wherein the waste plastic-based foam comprises polyurethane (PUR) or polyisocyanurate (PIR), preferably PUR.

6. A method according to any one of clauses 2 to 5, wherein the natural aggregate comprises one or more small aggregate.

7. A method according to clause 6 wherein the diameter of the one or more small aggregate is between 0 mm and 4 mm.

8. A method according to either clause 6 or 7, wherein the one or more small aggregate comprises sand, preferably sharp sand.

9. A method according to any preceding clause, wherein the natural aggerate comprises one or more large aggregate.

10. A method according to clause 9, wherein the diameter of the one or more large aggregate is between 4.01 mm and 20 mm, preferably between 4.01 mm and 15 mm, more preferably between 5 mm and 10 mm.

11. A method according to clause 9 or 10, wherein the one or more large aggregate comprises limestone, dolomite, granite, basalt, sandstone, quartzite, preferably limestone.

12. A method according to any preceding clause wherein the cementitious binder comprises a slag (such as ground-granulated blast-furnace slag (GGBS)), pulverised fly ash, geopolymers, pozzolans and/or cement, preferably a slag (such as GGBS) and/or cement, more preferably cement.

13. A method according to any preceding clause wherein the components further comprise a secondary aggregate.

14. A method according to any preceding clause wherein the components further comprise an admixture.

15. A method according to any preceding clause comprising one or more of the following pre-steps:
(i). receiving the waste plastic-based foam from recycler or manufacturer; and/or
(ii). granulating the waste plastic-based foam to form a mixture of plastic particles; and/or
(iii). treating the mixture to form a treated mixture; and/or
(iv). sieving the mixture to size separate the plastic particles; and/or
(v). reforming the mixture by contacting the plastic particles of different sizes with one another.

16. A method according to clause 15, wherein the waste plastic-based foam in step (i) is received in the form of pellets, powders, panels or briquettes.

17. A method according to any one of clauses 15 or 16 comprising the further step of using the concrete composition to produce a concrete building component, preferably wherein the concrete building component is a concrete block.

18. A method according to any one of clauses 15 to 17, wherein the plastic aggregate has a size distribution of 0 mm to 2 mm, preferably 0 mm to 1 mm.

19. A method according to any one of clauses 15 to 17, wherein the plastic aggregate has a size distribution of 2 mm to 40 mm, preferably 5 mm to 10 mm.

20. A concrete composition or building component obtainable by the method according to any of one of the preceding clauses.

21. A concrete composition comprising a plastic aggregate, preferably wherein the plastic aggregate is derived from waste plastic-based foam.

22. A concrete composition according to clause 21, further comprising:
i) a cementitious binder; and/or
ii) a natural aggregate; and/or
iii) water.

23. A concrete composition according to either clause 21 or 22, wherein the waste plastic-based foam is a rigid or flexible foam, preferably rigid foam.

24. A concrete composition according to any one of clauses 21 to 23, wherein the plastic aggregate (such as the waste plastic-based foam) comprises an isocyanate-based foam, preferably polyurethane (PUR) or polyisocyanurate (PIR), preferably PUR.

25. A concrete composition according to any one of clauses 21 to 24, wherein the plastic aggregate has a size distribution of 0 mm to 2 mm, preferably 0 mm to 1 mm.

26. A concrete composition according to any one of clauses 21 to 24, wherein the plastic aggregate has a size distribution of 2 mm to 40 mm, preferably 5 mm to 10 mm.

27. A concrete composition according to any one of clauses 21 to 26, wherein the composition comprises between 10 and 90 wt % of natural aggregate, preferably between 20 and 85 wt %, more preferably between 30 and 80 wt %.

28. A concrete composition according to any one of clauses 21 to 27, wherein the natural aggregate comprises one or more small aggregate.

29. A concrete composition according to clause 28 wherein the diameter of the one or more small aggregate is between 0 mm and 4 mm.

30. A concrete composition according to clause 28 or 29 wherein the composition comprises 0 to 90 wt %, preferably 0 to 80 wt %, more preferably 0 to 70 wt % small aggregate.

31. A concrete composition according to any one of clauses 28 to 30, wherein the composition comprises 0 to 60 wt %, preferably 0 to 50 wt %, more preferably 10 to 50 wt % small aggregate.

32. A concrete composition according to any one of clauses 28 to 30, wherein the composition comprises 0 to 90 wt %, preferably 10 to 80 wt %, more preferably 15 to 70 wt % small aggregate.

33. A concrete composition according to any one of clauses 28 to 30, wherein the composition comprises 0 to 50 wt %, preferably 0 to 45 wt %, more preferably 0 to 40 wt % small aggregate.

34. A concrete composition according to any one of clauses 28 to 33, wherein the one or more small aggregate comprises sand, preferably sharp sand.

35. A concrete composition according to any one of clauses 21 to 34, wherein the natural aggregate comprises one or more large aggregate.

36. A concrete composition according to clause 35 wherein the diameter of the one or more large aggregate is between 4.01 mm and 20 mm, preferably between 4.01 mm and 15 mm, more preferably between 4.01 mm to 10 mm.

37. A concrete composition according to either clause 35 or 36, wherein the composition comprises 0 to 90 wt %, preferably 0 to 80 wt %, more preferably 0 to 70 wt % large aggregate.

38. A concrete composition according to any one of clauses 35 to 37, wherein the composition comprises 0 to 60 wt %, preferably 5 to 60 wt %, more preferably 5 to 50 wt % large aggregate.

39. A concrete composition according to any one of clauses 35 to 37, wherein the composition comprises 0 to 90 wt %, preferably 5 to 80 wt %, more preferably 5 to 60 wt % large aggregate.

40. A concrete composition according to any one of clauses 35 to 37, wherein the composition comprises 0 to 50 wt %, preferably 0 to 45 wt %, more preferably 0 to 40 wt % large aggregate.

41. A concrete composition according to any one of clauses 35 to 40, wherein the one or more large aggregate comprises limestone, dolomite, granite, basalt, sandstone, quartzite, preferably limestone.

42. A concrete composition according to any one of clauses 21 to 41, comprising 2 to 75 wt %, preferably 5 to 65 wt %, more preferably 5 to 50 wt % cementitious binder.

43. A concrete composition according to any one of clauses 21 to 42, comprising 10 to 60 wt %, preferably 10 to 50 wt %, more preferably 15 to 50 wt % cementitious binder.

44. A concrete composition according to any one of clauses 21 to 42, comprising 2 to 60 wt %, preferably 3 to 50 wt %, more preferably 4 to 40 wt % cementitious binder.

45. A concrete composition according to any one of clauses 21 to 42, comprising 5 to 75 wt %, preferably 5 to 65 wt %, more preferably 5 to 55 wt % cementitious binder.

46. A concrete composition according to any one of clauses 22 to 45, wherein the cementitious binder comprises a slag (such as GGBS), pulverised fly ash, geopolymers, pozzolans and/or cement, preferably a slag (such as GGBS) and/or cement, preferably cement.

47. A concrete composition according to any one of clauses 21 to 46, comprising 1 to 75 wt %, preferably 1 to 65 wt %, more preferably 1 to 55 wt %, even more preferably 1 to 50 wt %, yet more preferably 1 to 40 wt % plastic aggregate.

48. A concrete composition according to any one of clauses 21 to 46, comprising 5 to 60 wt %, more preferably 10 to 50 wt % plastic aggregate.

49. A concrete composition according to any one of clauses 21 to 48 wherein the wt % of the water is between 1 and 20 wt %, preferably between 2 and 20 wt %, more preferably between 2 and 15 wt %.

50. A concrete composition according to any one of clauses 21 to 49, wherein the composition further comprises a secondary aggregate, preferably wherein the composition comprises between 10 and 90 wt % of the secondary aggregate, preferably between 20 and 85 wt %, more preferably 30 and 80 wt %.

51. A concrete composition according to clause 50 wherein the secondary aggregate comprises demolition waste, preferably crushed concrete.

52. A concrete composition according to any one of clauses 21 to 51, wherein the plastic aggregate comprises plastics particles that have been treated with low pressure plasma or electron beam.

53. A concrete composition according to any one of clauses 21 to 52, wherein the concrete composition is in the form of a concrete building component, preferably a concrete block.

54. A concrete composition according to clause 53, having a carbon footprint of −0.5 to 0.2 kg CO₂ eq per kg of concrete composition, preferably −0.35 to 0.05 kg CO₂ eq per kg of concrete composition.

55. A concrete composition according to any one of clauses 21 to 54, having thermal conductivity of 0.1 to 1 W/mK, preferably 0.2 to 0.8 W/mK, more preferably 0.3 to 0.5 W/mK.

56. A concrete composition according to any one of clauses 21 to 55, having thermal conductivity of 0.5 to 1.6 W/mK, preferably 0.6 to 1.4 W/mK, more preferably 0.7 to 1.2 W/mK.

57. A concrete composition according to any one of clauses 21 to 56, having a compressional strength of 1 to 60 N/mm², preferably 3 to 40 N/mm², more preferably 3.6 to 22.5 N/mm².

58. A concrete composition according to any one of clauses 21 to 57, having a density of 600 to 2500 kg/m³, preferably 1200 to 1600 kg/m³, more preferably 1350 to 1550 kg/m³.

59. A concrete composition according to any one of clauses 21 to 57, having a density of 1500 to 2500 kg/m³, preferably 1600 to 2200 kg/m³, more preferably 1700 to 2100 kg/m³.

60. A concrete composition according to clauses 21 to 59, comprising a cementitious binder, a large aggregate and at least 7 wt %, such as at least 10 wt % plastic aggregate.

61. A concrete composition according to clauses 21 to 59, comprising a large aggregate, GGBS, and a plastic aggregate.

62. A concrete composition according to clauses 21 to 61, wherein the plastic aggregate is derived from waste plastic-based foam.

63. A concrete composition according to clauses 21 to 62, wherein the composition further comprises an additive, preferably the additive is graphene or a pigment.

### EXAMPLES

### Materials

The following materials were used as supplied:
Cement supplied by Hanson
Granulated ground blast furnace slag (GGBS) supplied by Hanson
Granulated ground blast furnace slag (GGBS) supplied by Lkab
Large aggregate (10 mm Limestone) supplied by MKM Building Supplies
Small aggregate (sharp sand—0-4 mm) supplied MKM Building Supplies
Water
PUR Plastic Aggregate (derived from PUR rigid foam)
NaOH supplied by Inovyn
Na₂CO₃ supplied by DirectChem
Graphene suspension supplied by Graphene Star
Limestone powder supplied by Longcliffe
Calcined Clay supplied by Materials Marketing
High Strength Cement (HSC) supplied by Hanson

### Examples 1 and 2—Manufacturing Concrete Blocks

### Method

Received PUR rigid foam as pellets/powder from recycler or manufacturer
Granulated foam to make plastic smaller/break particles up
Sieved to size separate the plastic particles
Reformulated the plastics particles by mixing sieved fractions in a desired ratio to ensure that the optimal size distribution of said plastic particles for incorporation Into the concrete blocks
Block production; The reformulated plastics particles (i.e. the plastic aggregate) was mixed with other aggregates (cement, GBBS, limestone and sharp sand) in the optimal proportions (shown in Table 1) and water was added to make a concrete block using a 100 mm×100 mm×100 mm mould. The mixture was compressed to form a 100×100×100 mm block.

The following cement blocks have been prepared using the amounts of cement, GGBS, limestone, sharp sand, water and plastic particles shown in Table 1.

TABLE 1
Exemplary block formulations

| | | | 4-10 mm | Sharp | | |
|---|---|---|---|---|---|---|
| | Cement/ | GGBS/ | Limestone/ | Sand/ | Water/ | Plastic/ |
| Block | kg | kg | kg | kg | kg | kg |
| Example 1 | 5.11 | 0 | 1.19 | 4.6 | 1.38 | 3.06 |
| Example 2 | 1.43 | 1.43 | 10.77 | 4.23 | 1.14 | 0.6 |

### Technical Properties

The compressional strength (Table 2), thermal conductivity (Table 3), density (Table 3) and carbon footprint (Table 3) have been determined for the concrete blockwork.

### Compressional Strength

TABLE 2
Compressional strength of Example blocks

| | 14 Day Compressional | 28 Day Compressional |
|---|---|---|
| Block | Strength/N/mm² | Strength/N/mm² |
| Example 1 | 5.49 | 7.98 |
| Example 2 | 9.62 | — |

TABLE 3
Density, thermal conductivity and
carbon footprint of Example blocks

| | | Thermal | Carbon/ |
|---|---|---|---|
| | Density/ | conductivity/ | kg CO2eq per |
| Block | kg/m³ | W/m K | kg concrete |
| Example 1 | 1450 | 0.42 | −0.21 |
| Example 2 | 1950 | 1.22 | 0 |

### Conclusion

The concrete blocks have similar compressional strengths as incumbent blocks (as per British standard, for example, a popular class of incumbent blocks have compressional strengths of 7.3 N/mm²), but advantageously have lower thermal conductivities. Blocks that have lower thermal conductivities are advantageous as they can contribute to lower U-values in wall/floor build ups. This reduces the operational carbon footprint of buildings. They have demonstrated that they have the properties required to be used in the building industry, thus providing a useful re-use of waste plastics based foams instead of incinerating them and harming the environment.

### Example 3—Manufacturing of a Plastic Aggregate

Mix designs:
Preferred mix
PUR:GGBS 1:1.2
Water/GGBS 0.4
Sodium hydroxide 5% w/w of GGBS
Sodium carbonate 5% w/w of GGBS

### Method

After receiving PUR rigid foam as pellets/powder from recycler or manufacturer, the plastic was treated (granulated, sieved and reformulated in the desired size distribution (greater than 0.2 mm and less than 4 mm)).

The desired amount of plastic powder (20.8 kg) and GGBS (25 kg) were added in a paddle mixer and stirred together for a few minutes to obtain a good dispersion of the two materials.

The activators (sodium hydroxide, 150 g, and sodium carbonate, 150 g) were added to the required water (10 kg). The solution was stirred vigorously until complete dissolution of the chemicals. At room temperature (20-25° C.) this sodium carbonate solution would not be stable, because the concentration is above the solubilisation limit. However, the solubilisation of NaOH generates enough heat to increase the solubility of sodium carbonate and to obtain complete dissolution of the chemicals.

As soon as the solution was ready (before it cooled down and caused the precipitation of sodium carbonate), it was added to PUR and GGBS in the mixer, while continuously stirring.

Once all the solution was added, the mix was stirred further for a few minutes, until a homogeneous wet powder-like mix was obtained (aggregate mix).

The pelletiser process begins with heating up the machine, by running through it a “primer mix” (sand, flour, wood shavings and vegetable oil). In this way, when the aggregate mix will be processed, the temperature of the process die will be already high enough to have the desired accelerating curing effect on the pellets. Typically, the temperature range is 50-100° C. The pelletising die is typically a disc or ring with a series of countersunk holes with a set compression ratio, the die hole diameter was 6 mm. A knife was used to cut the formed plastic aggregate to the desired length and to create a size distribution. The compression value of the die is the ratio of the die hole diameter and die thickness, the die thickness is 27 mm, giving a compression value of 4.5. Compression values can range from 4 to 8 depending on the aggregate produced and desired application.

The aggregate mix was processed through the pelletiser, (sieved while still uncured and moist to remove the fines (<2 mm)), and the fines were collected to be recycled back into the system. The pellets >2 mm came out of the sieve and onto a conveyor belt and loaded into a bulk bag which stays warm for multiple days and set aside for a minimum of 4 days to cure.

Once the plastic aggregate had cured enough, it was then sieved again using a 2 mm screen to remove any of the fines, this material was then collected in a bulk bag and was ready to be used in concrete applications, however the curing process of the GGBS in the aggregate will continue for weeks and undergo carbonation, which will further increase the strength of the aggregate. Any unreacted GGBS left in the aggregate before use is expected to react with the cementitious binder such as Portland cement that is present in the concrete due to the high alkalinity of Portland cement.

### Compressive Strength Testing

The compressive strength of precast concrete made with plastic aggregate pellets (25% of the volume of the large aggregate) has been compared with the compressive strength of precast concrete in which the same volume of the large aggregate (25%) is substituted by:
the plastic aggregate mix left to cure without pelletisation, to show that forming into an aggregate without the heat and pressure of the present invention results in a concrete with worse properties than concrete of the present invention,
A PUR-only pellet aggregate, without GGBS and the chemicals, to show that the cementitious binder improves the strength of the concrete of the present invention,
PUR powder, to demonstrate that putting PUR into concrete without forming it into a larger particle results in a concrete with worse properties than concrete of the present invention.

The mix designs used for the preparation of the precast concrete are summarised in Table 4.

TABLE 4
Mix designs of precast concrete.

| | OPC/ | Large | Sand | Synthetic | Water/ |
|---|---|---|---|---|---|
| | kg | Aggregate/kg | kg | Aggregate/kg | kg |
| Plastic | 3.500 | 5.623 | 6.647 | 0.730 | 1.575 |
| aggregate | | | | | |
| pellets | | | | | |
| Plastic | 3.500 | 5.623 | 6.647 | 0.665 | 1.575 |
| aggregate mix | | | | | |
| PUR-only | 3.500 | 5.623 | 6.647 | 0.495 | 1.575 |
| pellets | | | | | |
| PUR powder | 3.500 | 5.623 | 6.647 | 0.460 | 1.575 |

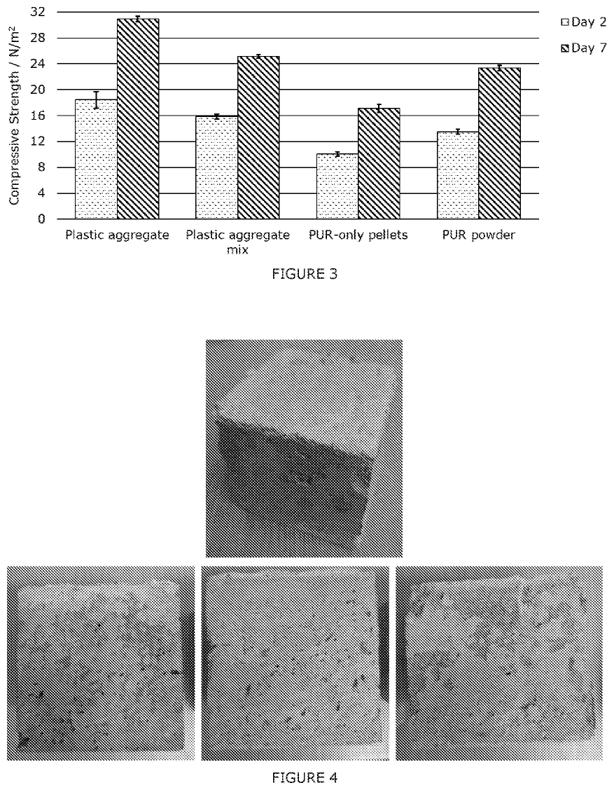

The concrete was cast into 10×10 cm moulds and crushed after 2 and 7 days of curing (3 moulds each time). The results are summarised in FIG. 3.

FIG. 3 shows that the concrete comprising plastic aggregate had higher compressive strength compared to the concrete comprising (i) the plastic aggregate mix (i.e. left to cure without pelletisation), or (ii) PUR-only pellets, or (iii) PUR powder. The concrete comprising plastic aggregate had higher compressive strength after both 2 days and 7 days of curing.

To better show the segregation of PUR in concrete and the better dispersion of the plastic aggregate, two more mixes were made, in which only either PUR plastic or plastic aggregate pellets were used as aggregate.

The mix is prepared by placing 2 kg of cement in a 5 L bucket and filling it to the top with either plastic aggregate pellets or powdered PUR, to achieve the same volume of ingredients. The amount of water required to make similar consistencies was added to the mixture. More water is required by the powdered PUR. The mix designs used are summarised in Table 5.

TABLE 5
Mix designs of precast concrete with plastic
aggregate pellets or PUR powder.

| Mix | | Plastic Aggregate | PUR | |
|---|---|---|---|---|
| # | OPC/kg | pellets/kg | powder/kg | Water/kg |
| 1 | 2.000 | 2.700 | | 1.300 |
| 2 | 2.000 | — | 1.700 | 1.700 |
| 3 | 2.000 | — | 1.700 | 2.500 |

The compressive strength and density of the concrete are summarised in Table 6.

TABLE 6
Compressive strength and density of the concrete.

| | Compressional | Compressional | |
|---|---|---|---|
| Mix | strength | strength | Density/ |
| # | 3 day/mpa | 7 day/mpa | kg m³ |
| 1 | 9.1 | 11.4 | 1281 |
| 2 | 2.2 | 3.3 | 865 |
| 3 | 1.0 | 1.9 | 766 |

FIG. 4 shows concrete cubes, showing mix 1 (left), 2 (centre bottom) and mix 3 (right). The top picture is a concrete cube corresponding to mix 2.

Mix 1, 2 and 3 in FIG. 4 correspond to mix 1, 2 and 3 as shown in Tables 5 and 6.

It can be seen in FIG. 4 that the concrete cubes corresponding to mix 2 and 3 contain lots more cracks on the surface compared to the concrete cube corresponding to mix 1. Additionally, the top of the concrete for mix 2&3 have a layer of separated plastic on the top due to separation (top picture in FIG. 4).

These results show that incorporation of plastic aggregate pellets leads to improved dispersion of the plastic into the concrete and stronger concrete.

The effect of activators, sodium hydroxide and sodium carbonate, was tested by measuring the compressive strength of GGBS-based concrete over time, with sodium hydroxide or carbonate alone (10% in weight of GGBS) and with both together (5% in weight of GGBS of each). The mix designs for the three samples are summarised in Table 7.

TABLE 7
Mix designs of GGBS based concrete.

| | | Large | | | | |
|---|---|---|---|---|---|---|
| | GGBS/ | Aggregate/ | Sand/ | NaOH/ | Na₂CO₃/ | Water/ |
| | kg | kg | kg | kg | kg | kg |
| Sample | 5.000 | 12.500 | 4.900 | 0.500 | — | 2.500 |
| 1 | | | | | | |
| Sample | 5.000 | 12.500 | 4.900 | — | 0.500 | 2.500 |
| 2 | | | | | | |
| Sample | 5.000 | 12.500 | 4.900 | 0.250 | 0.250 | 2.500 |
| 3 | | | | | | |

The concrete was cast into 10×10 cm moulds and crushed after 1, 3 and 7 days of curing (3 moulds each time). The results are summarised in FIG. 5.

FIG. 5 shows the effect of sodium hydroxide and sodium carbonate (“activators”) on the curing of GGBS. Sodium hydroxide alone can speed up the early strength gain, with a comparable strength after one day that using both the chemicals. After that though, the strength remains lower. The addition of sodium carbonate does not affect the early strength (after 1 day) but improves significantly the final strength. Technical advantages are thus obtained when there is one chemical present, or a combination of two or more (such as the sodium hydroxide and sodium carbonate demonstrated). In conclusion, the activator solution for GGBS results in a quicker early strength gain and a higher final strength.

### Conclusions

The compressive strength of concrete made with the same volume of plastic aggregate pellets, plastic aggregate mix, PUR-only pellets, and PUR powder, substituting 25% volume of large aggregate, clearly shows higher values for the plastic aggregate pellets of this invention. This represents evidence that the method (particularly the heat and pressure (e.g. pelletiser), the presence of a cementitious binder and of the inorganic base activator) Improves the property of the final concrete obtained when waste plastic is incorporated. The method essentially is an effective way to improve the dispersion and compatibility of the waste plastic into the concrete matrix.

### Example 4—Manufacturing of Graphene-Containing Plastic Aggregate Method

The PUR rigid foam was treated as explained in Examples 1-3 (granulated, sieved and reformulated in the desired size distribution (between 0.2 mm and 4 mm)).

The desired amount of plastic powder and GGBS were added in a paddle mixer and stirred together for a few minutes to obtain a good dispersion of the two materials. While continuously stirring, graphene was added by weighing a variable amount of the dispersion suspension, and then the added water was adjusted, to take into account the water added already with the graphene suspension, so that the total water added is always the same for all the pellets. Sample 1 was prepared as a control sample without adding graphene. The quantities of materials used are summarised in Table 8.

TABLE 8
Mix designs for graphene-containing plastic aggregate

| | | | Graphene | | | |
|---|---|---|---|---|---|---|
| Sample | GGBS/ | PUR/ | suspension/ | NaOH/ | Na₂CO₃/ | Water/ |
| # | kg | kg | g | kg | kg | kg |
| 1 | 2.4 | 2 | 0 | 0.12 | 0.12 | 1.056 |
| 2 | 2.4 | 2 | 50 | 0.12 | 0.12 | 1.006 |
| 3 | 2.4 | 2 | 100 | 0.12 | 0.12 | 0.956 |
| 4 | 2.4 | 2 | 150 | 0.12 | 0.12 | 0.906 |
| 5 | 2.4 | 2 | 200 | 0.12 | 0.12 | 0.856 |
| 6 | 2.4 | 2 | 400 | 0.12 | 0.12 | 0.656 |

Once all the required water was added, the mix was stirred further for a few minutes, until a homogeneous wet powder-like mix was obtained (aggregate mix).

Each aggregate mix was processed through the pelletiser and collected into a plastic tub and set aside for a minimum of 4 days to cure. Once the graphene-enhanced plastic aggregate had cured enough, it was ready to be analysed and used in concrete testing.

### Resistance to Tumbling

A rock tumbler has been used to test the strength and resistance of aggregate, as an in-house adaptation of the Los Angeles test (BS EN 1097-2).

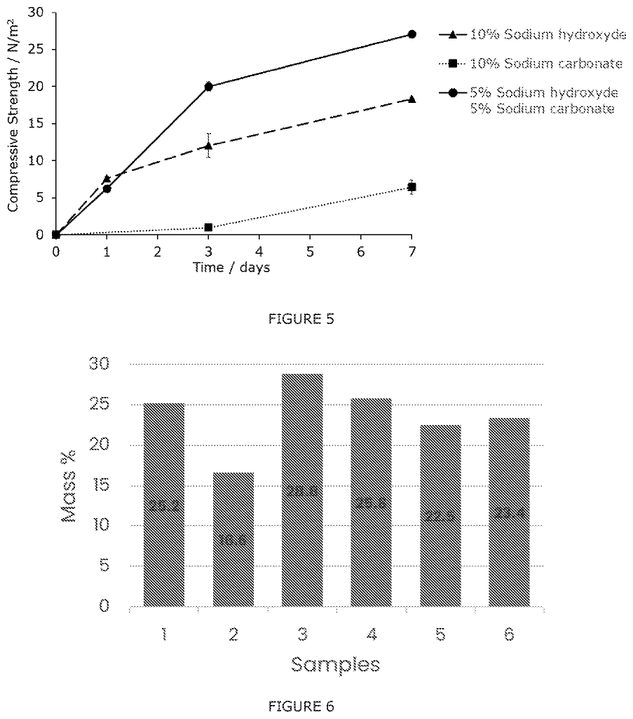

The aggregate has been tumbled for 20 hours and the % mass variation of the fines (<2 mm) has been measured. The results are shown in FIG. 6.

The lower the number of fines after tumbling, the stronger the pellets tested.

FIG. 6 shows that samples 2, 5 and 6 are stronger than the control without graphene (Sample 1). Samples 3 and 4 are slightly less strong than the control. Despite this, all plastic aggregates comprising graphene resulted in stronger concrete compared to appropriate comparisons without graphene, as described below.

### Precast Concrete Compressive Strength

Precast concrete was made with graphene-plastic aggregate pellets replacing 25% and 50% of the volume of the large aggregate. The concrete samples are labelled as CX_Y, where X corresponds to the plastic pellets sample number as given above (in Table 8, i.e., samples 1 to 6) and Y is the vol % of large aggregate replaced. The mix designs are shown in Table 9.

TABLE 9
design mix for concrete comprising
graphene-plastic aggregate pellets

| | | | Large | | |
|---|---|---|---|---|---|
| Concrete | Cement/ | Sand/ | Aggregate/ | Pellets/ | Water/ |
| # | kg | kg | kg | kg | kg |
| C1_25 | 4.75 | 9.00 | 7.60 | 1.05 | 2.14 |
| C2_25 | 4.75 | 9.00 | 7.60 | 1.05 | 2.14 |
| C3_25 | 4.75 | 9.00 | 7.60 | 1.05 | 2.14 |
| C4_25 | 4.75 | 9.00 | 7.60 | 1.05 | 2.14 |
| C5_25 | 4.75 | 9.00 | 7.60 | 1.05 | 2.14 |
| C6_25 | 4.75 | 9.00 | 7.60 | 1.05 | 2.14 |
| C1_50 | 4.75 | 9.00 | 5.09 | 2.07 | 2.14 |
| C2_50 | 4.75 | 9.00 | 5.09 | 2.07 | 2.14 |

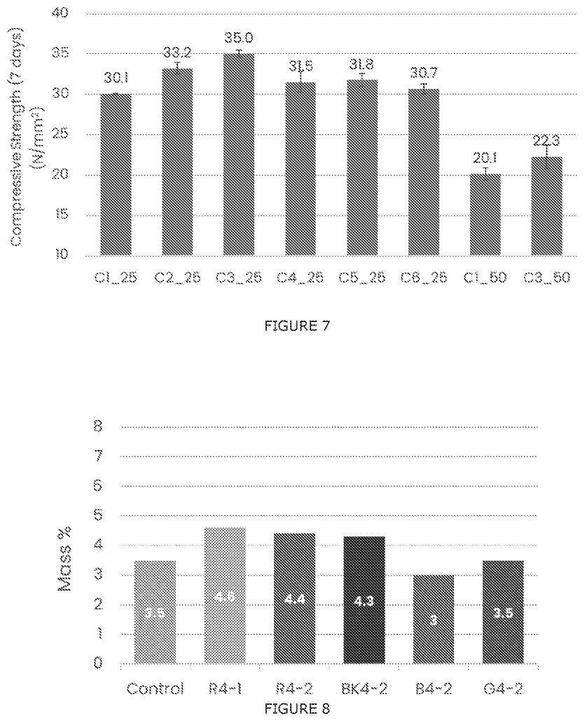

The compressive strength recorded after 7 days of curing are shown in the FIG. 7.

FIG. 7 shows that all compositions C2_25 to C6_25 (i.e., graphene containing) have a greater strength than C1_25 (no graphene). FIG. 7 also shows that the highest replacement of large aggregate (50%—C1_50 and C3_50) gives a lower strength as expected. However, the samples that gave the best results in the tumbler test (Samples 2, 5 and 6) also give stronger concrete, in comparison with the one made with the control pellets (Sample 1). This shows that the addition of the graphene improves the strength by 10-17%

### Conclusion

Addition of graphene as an additive in the plastic aggregate leads to improved strength of the plastic aggregate and improved strength of concrete comprising the graphene-containing plastic aggregate (by 10 to 17%).

### Example 5—Manufacturing of a Plastic Aggregate Using a Binder and No Alkaline Activator Solution

### Method

The PUR rigid foam was treated as explained in the previous examples (granulated, sieved and reformulated in the desired size distribution (between 0.2 mm and 4 mm)). The desired amount of plastic powder and the binders (GGBS, Limestone, Calcined Clay and HSC) were added in a paddle mixer and stirred together for a few minutes to obtain a good dispersion of the two materials. While continuously stirring, the required water was added, the mix was stirred further for a few minutes, until a homogeneous wet powder-like mix was obtained (aggregate mix). One sample was prepared, with a binder:PUR ratio of 1:5. The quantities of materials used are summarised in Table 10.

TABLE 10
design mix for a plastic aggregate using
no alkaline activator solution

| Sample | PUR/ | GGBS/ | Limestone/ | Calcined Clay/ | HSC/ | Water/ |
|---|---|---|---|---|---|---|
| # | kg | kg | kg | kg | kg | kg |
| 7 | 1.00 | 2.60 | 1.45 | 0.7 | 0.25 | 1.50 |

The aggregate mix was processed through the pelletiser as discussed above, sieved while still uncured and moist to remove the fines (<2 mm). The pellets >2 mm collected out of the sieve were collected into a plastic tub and set aside for a minimum of 4 days to cure. Once the plastic aggregate had cured enough, it was ready to be analysed.

### Resistance to Tumbling

After 20 hours of tumbling, the % mass variation of the fines (<2 mm) has been measured as 40.6%. If the aggregate did not undergo some amount of curing during the 4 days, then 90%+ fines would be expected as it would completely break up.

Due to using the HSC it would be expected that the strength of the aggregate to continue to increase further over time.

This result shows that it is possible for the binder mixture to cure with the use of a substance like HSC instead of a water soluble alkaline activator.

### Example 6—Manufacturing of Pigmented Aggregate

### Method

Pigmented pellets were prepared by preparing the aggregate as describe above, but adding the pigment to the powders in the paddle mixer and stirring together for a few minutes to obtain a good dispersion of the materials. For each colour, part of the PUR was replaced with pigment in 2 levels, 1% and 3.7% of the total mass. The pellets are labelled as XY-1 or XY-2, where X is related to the pigment colour used (R: red, G: green, B: blue, Y: yellow, BK: black), and Y is the die hole diameter (4, 6 or 8 mm), and -1 or -2 refer to the level of pigment in the mix (1 for the lower percentage, 1%; 2 for the higher percentage, 3.7%).

The quantities of materials used are summarised in the Table 11.

TABLE 11
design mix for manufacturing pigmented plastic aggregates

| Sample | GGBS/ | PUR/ | Pigment/ | NaOH/ | Na₂CO₃/ | Water/ |
|---|---|---|---|---|---|---|
| # | kg | kg | g | kg | kg | kg |
| Control | 1.2 | 1 | 0 | 0.06 | 0.06 | 0.4 |
| XY-1 | 1.2 | 0.97 | 2.72 | 0.06 | 0.06 | 0.4 |
| XY-2 | 1.2 | 0.90 | 10 | 0.06 | 0.06 | 0.4 |

Once all the required water was added, the mix was stirred further for a few minutes, until a homogeneous wet powder-like mix was obtained (aggregate mix).

Each aggregate mix was processed through the pelletiser, using a 4 mm, 6 mm and 8 mm die then collected into a plastic tub and set aside for 7 days to cure.

After 7 days of curing, each sample was tested in the tumbler resistance, to verify that the presence of pigments does not affect the pellets' stability. The results are discussed below.

In another test, cubes of concrete made with pigmented pellets were also exposed to sunlight for a few days, to test the UV stability of the pigments. The results are discussed below.

### Resistance to Tumbling

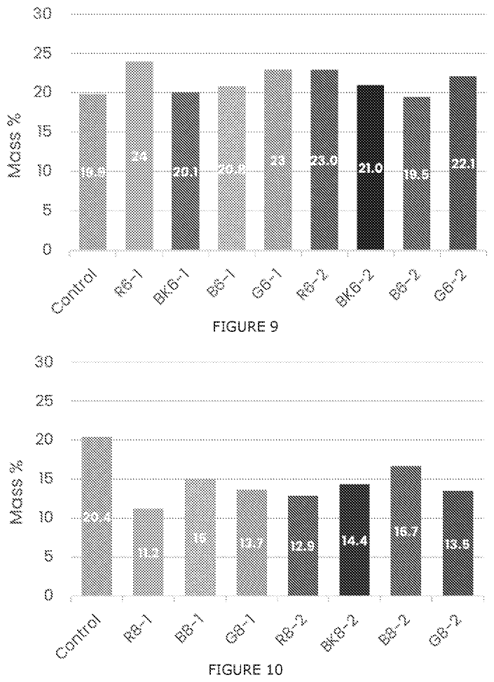

After 20 hours of tumbling, the % mass variation of the fines (<2 mm) has been measured. The results are shown in FIGS. 9 to 11.

FIG. 8 shows the results obtained with 4 mm pellets.

FIG. 9 shows the results obtained with 6 mm pellets.

FIG. 10 shows the results obtained with 8 mm pellets.

Overall, FIGS. 8 to 10 show that the 4 mm pellets are stronger (less amount of fines after tumbler) than the other 2 dimensions, because the smaller diameter of the die allows a higher pressure of the material through the pelletiser. Not much difference is seen between 6 and 8 mm. For the 4 and 6 mm pellets, the pigments, in the 2 different percentages, do not seem to affect the strength of the pellets, with the number of fines after tumbling comparable to the control without pigment for most of them. Red pigment, in both 4 and 6 mm pellets, black pigment for 4 mm pellets and green pigments for 6 mm pellets, gave between 10 and 30% more fines after tumbling than the control. However, this effect does not increase with the increasing amount of the same pigment in the mix, showing that it is likely not related to the pigment itself but to the error of the testing method.

For the 8 mm pellets, the addition of pigments gave stronger pellets with each colour and in both percentages of pigment in the mix.

### Sunlight Exposure

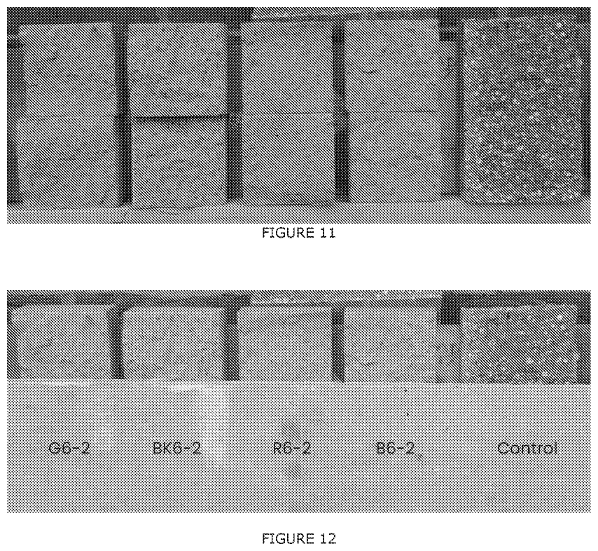

Some of the pigmented pellets and the control pellets were used as aggregate to make concrete, and the cubes were partially exposed to sunlight and partially not, to verify the stability of the plastic and of the colours under sunlight. The setup is shown in FIGS. 11 and 12.

FIG. 11 shows four stacks of two cubes each, and a control cube.

FIG. 12 shows that the top cubes and the top half of the control cube are partially exposed to sunlight; and that the bottom cubes and the bottom half of the control cube is covered.

The cubes were exposed for 2 months. The comparisons between the exposed and unexposed cubes revealed that the colour of the pigment is not affected by the sunlight. The concrete surfaces exposed to sunlight but which contained the pigmented plastic aggregate were not observed to be yellow.

However, the control concrete (without pigment) turned yellower under sunlight.

### Conclusions

Concrete blocks comprising plastic tend to turn yellow over time when exposed to sunlight, which is undesired. Pigmenting the plastic aggregate represents an advantage, as the yellowing of concrete comprising the pigmented aggregate is diminished or no longer visible, while the colour of the pigment is not affected by sunlight.

1. A method of manufacturing a plastic aggregate comprising the steps of:
(i) mixing plastic and at least one cementitious binder to form a first composition, wherein the particles of the plastic have a size distribution between 0.1 to 6 mm;
(ii) providing a second composition comprising water;
(iii) mixing together the first and second compositions to form a plastic aggregate mixture; and
(iv) compressing and heating the plastic aggregate mixture to form the plastic aggregate.

2. A method of claim 1, wherein the second composition further comprises at least one inorganic base selected from an alkali hydroxide, an alkali oxide, an alkali carbonate, a mixture of an alkali oxide and an alkali carbonate, sodium hydroxide, sodium carbonate, or combinations of any of the foregoing.

3. A method of claim 1, wherein the particles of the plastic have a size distribution selected from 0.2 to 5 mm, 0.2 to 4 mm, 0.2 to 3 mm, and 0.2 to 2 mm.

4. A method of claim 1, wherein the at least one cementitious binder is selected from GGBS, cement or fly ash, Portland cement, or a mixture thereof.

5. (canceled)

6. A method according to claim 1, wherein the compressing and/or the heating is done by pelletisation and the plastic aggregate is in the form of a pellet.

7. A method of claim 6, wherein the width of the plastic aggregate pellet is 0.5 to 10 mm, preferably 2 to 8 mm; and/or
the aspect ratio between the length of the pellet and the width of the pellet is 0.05 to 20.

8. (canceled)

9. A method according to claim 1, wherein the plastic is derived from waste plastic-based foam comprising polyurethane (PUR) or polyisocyanurate (PIR).

10. A method according to claim 1, wherein:
the weight ratio of plastic to cementitious binder in the plastic aggregate mixture and/or the plastic aggregate is from 2:1 to 1:7; and/or
the weight ratio of water to cementitious binder in the plastic aggregate mixture and/or the plastic aggregate is from 0.2 to 0.6.

11-16. (canceled)

17. A method according to claim 1, further comprising the step of adding a filler during or between any one of steps (i), (ii) or (iii), wherein the filler is limestone or calcined clay.

18-19. (canceled)

20. A plastic aggregate pellet comprising:
(i) a plastic comprising particles having a size distribution between 0.1 to 6 mm;
(ii) at least one cementitious binder; and
(iii) water.

21. A plastic aggregate pellet according to claim 20, wherein:
the weight ratio of plastic to cementitious binder is from 2:1 to 1:7; and/or
weight ratio of water to cementitious binder is from 0.2 to 0.6.

22. A plastic aggregate pellet according to claim 21, wherein the particles of the plastic derived from waste plastic-based foam have a size distribution selected from 0.2 to 5 mm, 0.2 to 4 mm, 0.2 to 3 mm, and even 0.2 to 2 mm.

23. A plastic aggregate pellet according to claim 20, wherein the at least one cementitious binder is selected from GGBS, cement or fly ash, Portland cement or a mixture thereof.

24. A plastic aggregate pellet according to claim 20, comprising at least one inorganic base selected from as an alkali hydroxide, an alkali oxide, an alkali carbonate, a mixture of an alkali hydroxide and an alkali oxide, sodium hydroxide, sodium carbonate, or combinations of any of the foregoing.

25. (canceled)

26. A plastic aggregate pellet according to claim 20, wherein the plastic is derived from a waste plastic-based foam comprising an isocyanate-based foam, polyurethane (PUR) or polyisocyanurate (PIR).

27-28. (canceled)

29. A plastic aggregate pellet according to claim 20, wherein the pellet further comprises from 0.01 to 5 wt % of at least one additive selected from an admixture, a strength enhancer, a rheology modifier, a pigment, or a fiber.

30-31. (canceled)

32. A plastic aggregate pellet according to claim 20, wherein the pellet further comprises from 0.01 to 30 wt % of at least one filler selected from limestone, sand, wood, clay, concrete dust, microsilica, or char, preferably limestone and/or calcined clay.

33. (canceled)

34. A plastic aggregate pellet according to claim 20, wherein the pellet comprises calcined clay, limestone, and high strength cement.

35. A concrete composition comprising the plastic aggregate pellet of claim 20.

36-37. (canceled)

38. A method of claim 1, further comprising the step of mixing the plastic aggregate and at least one cementitious binder to form a concrete composition.

39-41. (canceled)
